(19) United States
(12) Patent Application Publication
(10) Pub. No.: US 2012/0186443 A1
(43) Pub. Date: Jul. 26, 2012

(54) PISTON ASSEMBLY WITH A STAMPED ORIFICE

(75) Inventor: Philip George, Wooster, OH (US)

(73) Assignee: SCHAEFFLER TECHNOLOGIES AG & CO. KG, Herzogenaurach (DE)

(21) Appl. No.: 13/351,931

(22) Filed: Jan. 17, 2012

Related U.S. Application Data
(60) Provisional application No. 61/434,609, filed on Jan. 20, 2011.

(51) Int. Cl. F16J 1/00

(52) U.S. Cl. 92/172

(57) ABSTRACT

A piston assembly, including: a back plate and a piston fixed to the back plate and including: an indent circumferentially disposed proximate an outer circumference for the piston plate and including a radially disposed surface; and a groove in the indent. The assembly includes a sealing element at least partially disposed in the indent; and at least one resilient element in contact with the piston and applying a first pressure to urge the sealing element in a first axial direction to create a gap between the piston and the sealing element. When the gap is present, the groove provides a flow path from a chamber at least partially formed by the back plate to the gap. When the sealing element is sealed against the radially disposed surface the flow path is blocked.

### CROSS-REFERENCE TO RELATED APPLICATIONS

This application claims the benefit under 35 U.S.C. §119(e) of U.S. Provisional Application No. 61/434,609 filed Jan. 20, 2011, which application is incorporated herein by reference.

### TECHNICAL FIELD

The present disclosure relates to a clutch assembly, in particular, a clutch assembly for double-sided pressure loading and including a piston configured to enable bleeding of air from a pressure chamber.

### BACKGROUND

For a clutch assembly it is known to provide a means for bleeding air from a pressure chamber, in particular an apply pressure chamber, by machining an opening into a piston by drilling, reaming, or electric discharge machining, all of which are performed as secondary processes after fabrication of the piston.

### SUMMARY

According to aspects illustrated herein, there is provided a piston assembly, including: a back plate and a piston fixed to the back plate and including: an indent circumferentially disposed proximate an outer circumference for the piston plate and including a radially disposed surface; and a groove in the indent. The assembly includes a sealing element at least partially disposed in the indent. The groove provides a flow path from the back plate to an outer circumference of the piston when the sealing element is sealed against the radially disposed surface.

According to aspects illustrated herein, there is provided a piston assembly, including: a back plate and a piston fixed to the back plate and including: an indent circumferentially disposed proximate an outer circumference for the piston plate and including a radially disposed surface; and a groove in the indent. The assembly includes a sealing element at least partially disposed in the indent; and at least one resilient element in contact with the piston and applying a force to urge the sealing element in an axial direction to create a gap between the piston and the sealing element. When the gap is present, the groove provides a flow path from a chamber at least partially formed by the back plate to the gap. When the sealing element is sealed against the radially disposed surface the flow path is blocked.

According to aspects illustrated herein, there is provided a piston assembly, including: a back plate and a piston fixed to the back plate with a plurality of fasteners and including: an indent circumferentially disposed proximate an outer circumference for the piston plate and including a radially disposed surface and a circumferentially disposed surface; and a groove in the indent extending radially inward from the circumferentially disposed surface. The assembly includes a sealing element at least partially disposed in the indent; and at least one resilient element in contact with the piston and applying a force to urge the sealing element in an axial direction to create a gap between the piston and the sealing element. When the gap is present, the groove provides a flow path from a chamber partially formed by the back plate to an outer circumference of the piston. When the sealing element is sealed against the radially disposed surface the flow path is blocked. The at least one resilient element is separate from the sealing element and the piston; or the at least one resilient element is formed of a same piece of material as the sealing element.

These and other objects and advantages of the present disclosure will be readily appreciable from the following description of the invention and from the accompanying drawings and claims.

### BRIEF DESCRIPTION OF THE DRAWINGS

Various embodiments are disclosed, by way of example only, with reference to the accompanying schematic drawings in which corresponding reference symbols indicate corresponding parts, in which:

FIG. 1A is a perspective view of a cylindrical coordinate system demonstrating spatial terminology used in the present application;

FIG. 1B is a perspective view of an object in the cylindrical coordinate system of FIG. 1A demonstrating spatial terminology used in the present application; and,

FIG. 2 is a front view of a piston assembly with a groove for bleeding;

FIG. 3 is a partial cross-sectional view of piston assembly 100 shown in FIG. 2 generally along line 3-7-3-7 in FIG. 2, in a housing;

FIG. 4 is a partial cross-sectional view of the piston assembly shown in FIG. 2, with a spring, generally along line 3-7-3-7 in FIG. 2, in a housing, with the sealing element displaced from the piston;

FIG. 5 is a partial cross-sectional view of the piston assembly shown in FIG. 2, with a spring, generally along line 3-7-3-7 in FIG. 2, in a housing, showing the spring flattened;

FIG. 6 is a partial cross-sectional view of the piston assembly shown in FIG. 2, with a tab, generally along line 3-7-3-7 in FIG. 2, in a housing, with the sealing element displaced from the piston; and,

FIG. 7 is a partial cross-sectional view of the piston assembly shown in FIG. 2, with a tab, generally along line 3-7-3-7 in FIG. 2, in a housing, showing the tab flattened.

### DETAILED DESCRIPTION

At the outset, it should be appreciated that like drawing numbers on different drawing views identify identical, or functionally similar, structural elements of the disclosure. It is to be understood that the disclosure as claimed is not limited to the disclosed aspects.

Furthermore, it is understood that this disclosure is not limited to the particular methodology, materials and modifications described and as such may, of course, vary. It is also understood that the terminology used herein is for the purpose of describing particular aspects only, and is not intended to limit the scope of the present disclosure.

Unless defined otherwise, all technical and scientific terms used herein have the same meaning as commonly understood to one of ordinary skill in the art to which this disclosure belongs. It should be understood that any methods, devices or materials similar or equivalent to those described herein can be used in the practice or testing of the disclosure.

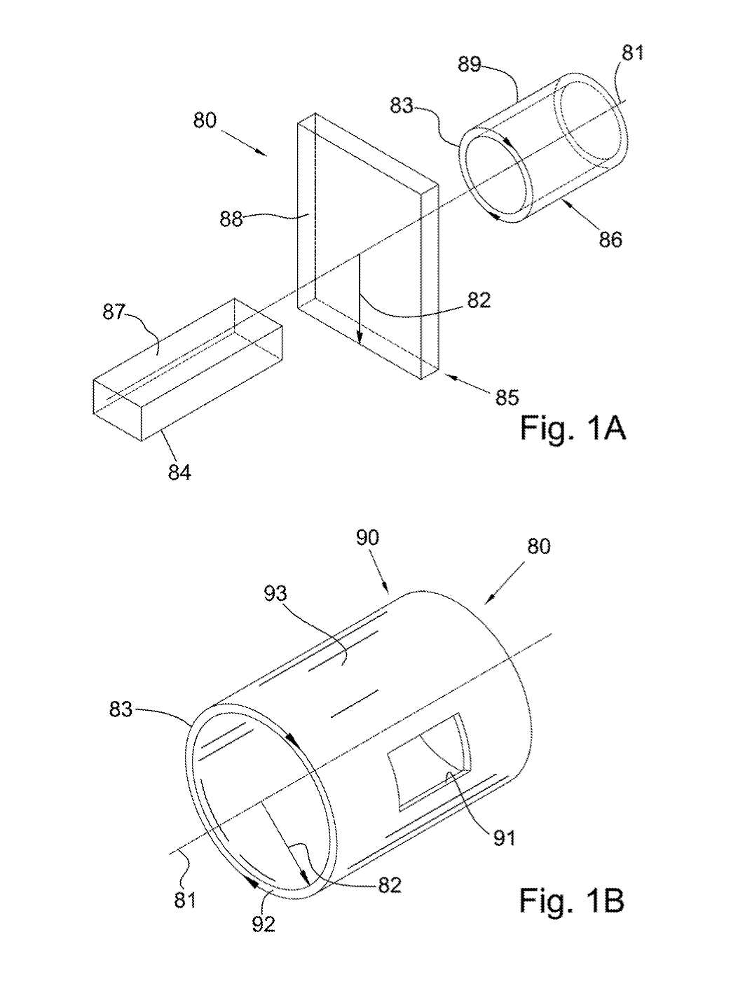

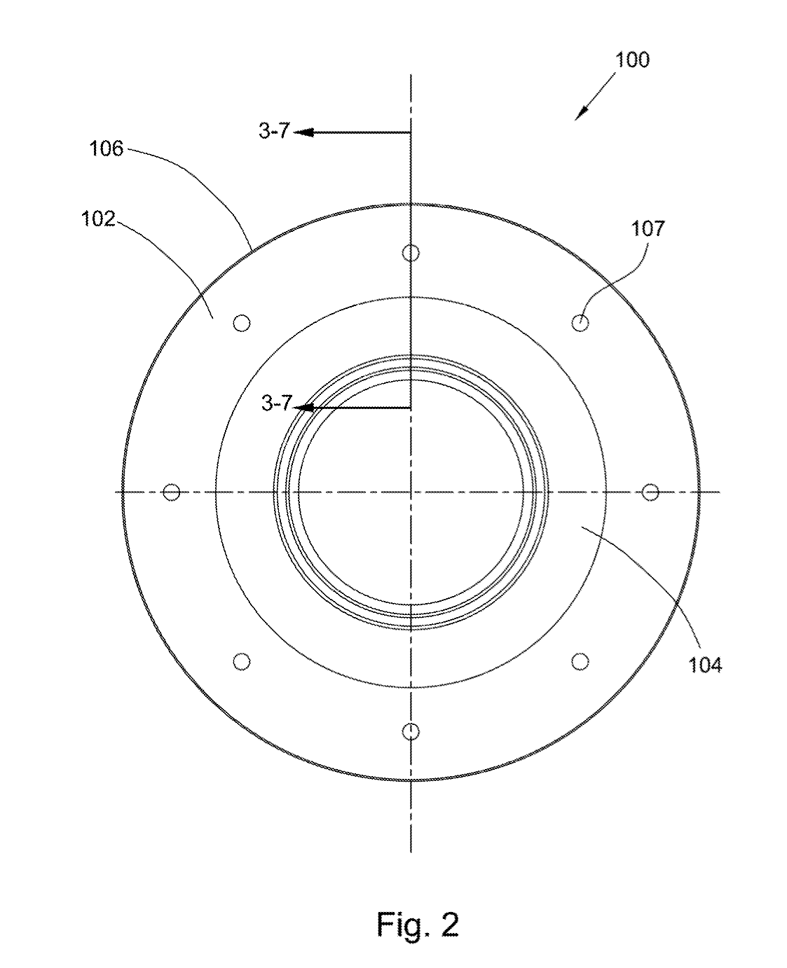

FIG. 1A is a perspective view of cylindrical coordinate system 80 demonstrating spatial terminology used in the present application. The present invention is at least partially described within the context of a cylindrical coordinate system. System 80 has a longitudinal axis 81, used as the reference for the directional and spatial terms that follow. The adjectives “axial,” “radial,” and “circumferential” are with respect to an orientation parallel to axis 81, radius 82 (which is orthogonal to axis 81), and circumference 83, respectively. The adjectives “axial,” “radial” and “circumferential” also are regarding orientation parallel to respective planes. To clarify the disposition of the various planes, objects 84, 85, and 86 are used. Surface 87 of object 84 forms an axial plane. That is, axis 81 forms a line along the surface. Surface 88 of object 85 forms a radial plane. That is, radius 82 forms a line along the surface. Surface 89 of object 86 forms a circumferential plane. That is, circumference 83 forms a line along the surface. As a further example, axial movement or disposition is parallel to axis 81, radial movement or disposition is parallel to radius 82, and circumferential movement or disposition is parallel to circumference 83. Rotation is with respect to axis 81.

The adverbs “axially,” “radially,” and “circumferentially” are with respect to an orientation parallel to axis 81, radius 82, or circumference 83, respectively. The adverbs “axially,” “radially,” and “circumferentially” also are regarding orientation parallel to respective planes.

FIG. 1B is a perspective view of object 90 in cylindrical coordinate system 80 of FIG. 1A demonstrating spatial terminology used in the present application. Cylindrical object 90 is representative of a cylindrical object in a cylindrical coordinate system and is not intended to limit the present invention in any manner. Object 90 includes axial surface 91, radial surface 92, and circumferential surface 93. Surface 91 is part of an axial plane, surface 92 is part of a radial plane, and surface 93 is a circumferential surface.

FIG. 2 is a front view of piston assembly 100 with a groove for bleeding.

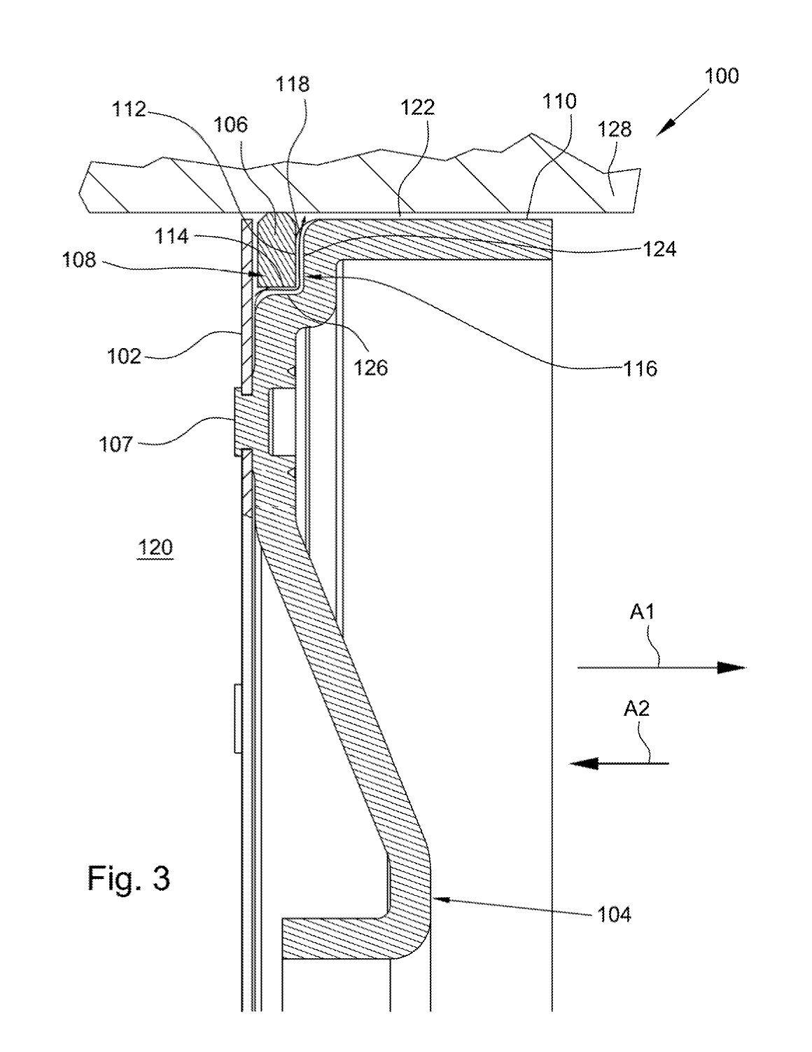

FIG. 3 is a partial cross-sectional view of piston assembly 100 shown in FIG. 2 generally along line 3-7-3-7 in FIG. 2 in a housing. The following should be viewed in light of FIGS. 2 and 3. In an example embodiment, piston assembly 100 includes back plate 102, piston 104, and sealing element 106. In an example embodiment, the sealing element is made of Teflon. The back plate is secured to the piston by plurality of fasteners 107. In an example embodiment, the fasteners are extruded rivets. In some example embodiments (not shown), plate 102 is fixed to piston 104 by welding or adhesives. The piston includes indent 108 circumferentially disposed proximate outer circumference 110 for the piston plate. The indent includes radially disposed surface 112, circumferentially disposed surface 114, and groove 116. Sealing element 106 is at least partially disposed in the indent. The groove provides flow path 118 from a chamber partially formed by the back plate, for example, chamber 120, to an outer circumference of the piston, for example, to space 122, when the sealing element is sealed against the radially disposed surface. Space 122 may be connected to a transmission sump (not shown).

Portion 124 of the groove is located in the radially disposed surface and extends axially beyond radially disposed surface 112, for example, in direction A1. Portion 126 of the groove extends radially inward from circumferentially disposed surface 114. Portions 124 and 126 are joined together, that is, the portions are in communication. When the sealing element is sealed against the radial surface 112, portions 124 and 126 form flow path 118.

The indent includes only one radially disposed surface, or side, 112, and only one axially disposed surface 114. Thus, a simple coining operation can be used to create the indent. The back plate and the piston, in particular, surface 114, axially retain the sealing element, eliminating the need for a circumferentially disposed groove, with two radially disposed and circumferentially extending walls, in the piston. Creating a groove would be more complex and costly than creating indent 108 and joining the back plate to the piston.

The piston assembly is arranged to be placed within housing 128 such that the sealing element creates a seal with the housing. In an example embodiment, the housing is part of a transmission housing and the piston assembly is part of a clutch in the transmission. In an example embodiment, piston assembly 100 is a non-rotating piston and is oriented so that groove 116 is closest to the top of the installed transmission.

When hydraulic pressure is applied to the piston in apply direction A1, for example, to close a clutch, the sealing element is pressed against the piston to create a seal with surface 112. The seal blocks flow of hydraulic fluid between the sealing element and surface 112 in direction A1 from chamber 120, enabling pressure build-up in the chamber, for example, to engage a clutch associated with the piston assembly. However, this seal also prevents bleeding of air from chamber 120 past the sealing element. Advantageously, groove 116 provides controlled flow path 118 through which air in chamber 120 can be bled to space 122. The groove can be sized to enable bleeding while minimizing pressure loss through the groove. That is, the bleeding action can be balanced against pressure loss through the groove.

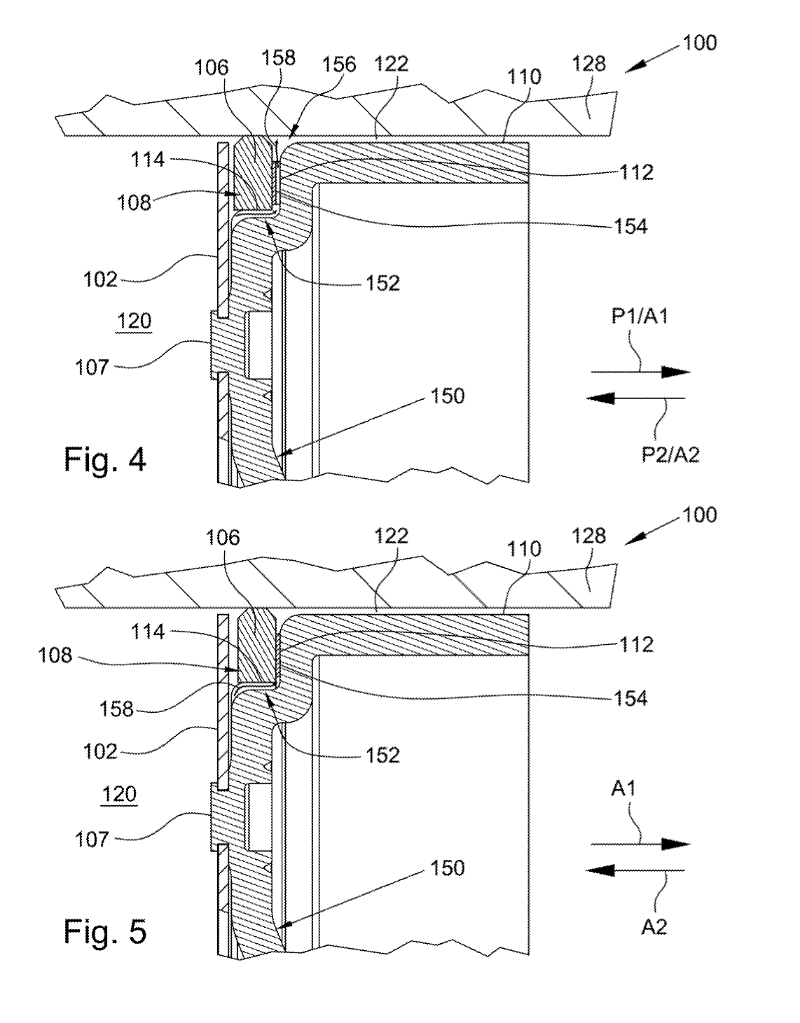

FIG. 4 is a partial cross-sectional view of piston assembly 100 shown in FIG. 2, with a spring, generally along line 3-7-3-7 in FIG. 2, in a housing.

FIG. 5 is a partial cross-sectional view of the piston assembly shown in FIG. 2, with a spring, generally along line 3-7-3-7 in FIG. 2, in a housing, showing the spring flattened. The following should be viewed in light of FIGS. 2 through 5. In an example embodiment, piston assembly 100 includes back plate 102, piston 150, and sealing element 106. In an example embodiment, the sealing element is made of Teflon. The back plate is secured to the piston by plurality of fasteners 107. In an example embodiment, the fasteners are extruded rivets. The piston includes indent 108 circumferentially disposed proximate outer circumference 110 for the piston plate. The indent includes radially disposed surface 112, circumferentially disposed surface 114, and groove 152. Sealing element 106 is at least partially disposed in the indent. The assembly includes at least one resilient element 154 in contact with the piston and applying pressure P2 to urge the sealing element in axial direction A2 to create gap 156 between the piston and the sealing element. When the gap is present, the groove provides flow path 158 from chamber 120, via gap 156, to outer circumference 116 of the piston, for example, to space 122. Groove 152 is located in the circumferentially disposed surface and extends radially inward from the circumferentially disposed surface. In an example embodiment, element 154 is separate from the sealing element, for example, element 154 is a spring. Any spring known in the art, including a wave spring, can be used for element 154.

The piston assembly is arranged to be placed within housing 128 such that the sealing element creates a seal with the housing. In an example embodiment, the housing is part of a transmission housing. In an example embodiment, the housing is part of a transmission housing and the piston assembly is part of a clutch in the transmission. In general, a liquid-tight seal is not formed between the radially inward circumference of the sealing element and surface 114 due to respective tolerances and material characteristics of the sealing element. Groove 152 provides a well defined flow path past the sealing element and surface 114.

Pressure P1, typically via hydraulic fluid, is applied to piston 104 in direction A1, opposite direction A2, for example, to displace the piston to engage a clutch. When pressure P1 is less than P2, the resilient element advantageously maintains gap 156 and flow path 158 through which air in chamber 120 can be bled. The groove and the gap can be sized to establish a ratio of air bleeding and pressure loss through the groove. When force from pressure P1 exceeds combined force from pressure P2 and the resilient element, the resilient element is flattened, enabling displacement of sealing element in direction A1. As a result, the sealing element is sealed against the flattened resilient element, which is turn forms a seal with surface 112. Gap 156 and flow path 158 are blocked, enabling pressure to be built-up and maintained in the chamber. For example, it is not necessary to continuously pump fluid into chamber 120 to maintain a desired pressure in the chamber. That is, the pressure in chamber 120 is not diminished by fluid passing through path 158 and gap 156. Thus, in the initial stage of applying pressure to the piston, bleeding of air from chamber 120 is enabled, and during the latter stage of applying pressure to the piston, the flow of fluid out of chamber 120 into space 122 is blocked.

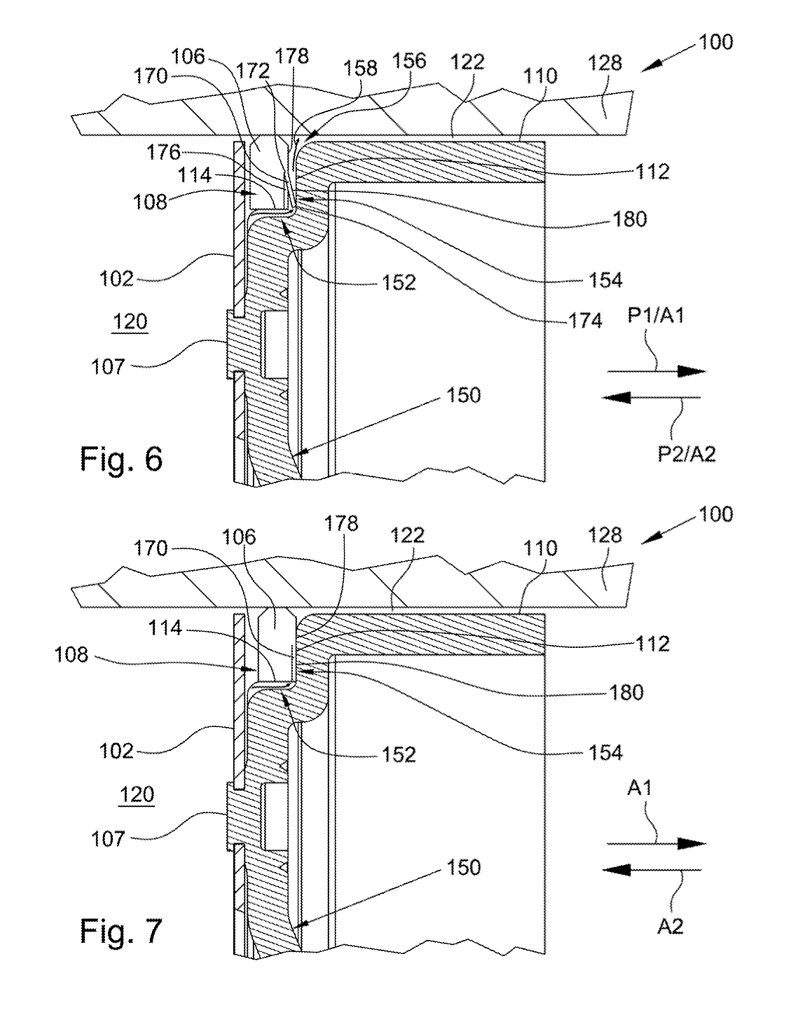

FIG. 6 is a partial cross-sectional view of the piston assembly shown in FIG. 2, with tabs, generally along line 3-7-3-7 in FIG. 2, in a housing, with the sealing element displaced from the piston. In an example embodiment, resilient element 154 is formed of a same piece of material as the sealing element. That is, element 154 is integral to the sealing element. For example, the resilient element includes at least one tab 170 connected at end 172 to the sealing element. The tab is biased so that distal end 174 of the tab extends axially away from the sealing element. That is, the tab is preloaded so that end 174 pushes in direction A1. End 174 is in contact with the piston and applies pressure P2 in direction A2 to maintain gap 156 between the sealing element and the piston. It should be understood that the tab does not extend all the way around the circumference of the sealing element, so that the tab does not block flow path 158 in FIG. 6. Further, if there are multiple tabs, there are circumferential spaces between the tabs for flow path 158.

The piston assembly is arranged to be placed within housing 128 such that the sealing element creates a seal with the housing. In an example embodiment, the housing is part of a transmission housing. In an example embodiment, the housing is part of a transmission housing and the piston assembly is part of a clutch in the transmission. In general, a liquid-tight seal is not formed between the radially inward circumference of the sealing element and surface 114 due to respective tolerances and material characteristics of the sealing element. Groove 152 provides a well defined flow path past the sealing element and surface 114.

As noted above, pressure P1, typically via hydraulic fluid, is applied to piston 104 in direction A1, opposite direction A2, for example, to displace the piston to engage a clutch. When pressure P1 is less than P2, the tab advantageously maintains gap 156 and flow path 158 through which air in chamber 120 can be bled. The groove and the gap can be sized to establish a ratio of air bleeding and pressure loss through the groove.

FIG. 7 is a partial cross-sectional view of the piston assembly shown in FIG. 2, with a tab, generally along line 3-7-3-7 in FIG. 2, in a housing, showing the tab flattened. When force from pressure P1 exceeds combined force from pressure P2 and the resilient element, the resilient element is flattened, enabling displacement of the sealing element in direction A1. As a result, the sealing element is sealed against surface 112 and gap 156 and flow path 158 are blocked, enabling pressure to be built-up and maintained in chamber 120. For example, it is not necessary to continuously pump fluid into chamber 120 to maintain a desired pressure in the chamber. That is, the pressure in chamber 120 is not diminished by fluid passing through path 158 and gap 156. Thus, in the initial stage of applying pressure to the piston, bleeding of air from chamber 120 is enabled, and during the latter stage of applying pressure to the piston, the flow of fluid out of chamber 120 into space 122 is blocked.

In an example embodiment, the sealing element includes at least one indentation 176 in radially disposed surface 178 facing the piston. Tab 170 and indentation 176 are configured so that in response to the sealing element displacing in direction A1, the tab is displaced into the indentation. In an example embodiment, the tab and indentation are configured so that surface 178 and surface 180 of the tab are radially aligned when the tab is disposed in the indentation. Thus, surfaces 178 and 180 present a uniform sealing surface for contacting the piston. In an example embodiment, the tab is sized so that only surface 180 contacts the piston.

In an example embodiment, tab 170 is separate from the sealing element and is fixed to the sealing element by any means known in the art. For example, tab 170 may be fixed to element 106 by an adhesive.

It will be appreciated that various of the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

What we claim is:

1. A piston assembly, comprising:
a back plate;
a piston fixed to the back plate and including:
an indent circumferentially disposed proximate an outer circumference for the piston plate and including a radially disposed surface; and,
a groove in the indent; and,
a sealing element at least partially disposed in the indent, wherein the groove provides a flow path from the back plate to an outer circumference of the piston when the sealing element is sealed against the radially disposed surface.

2. The piston assembly of claim 1, wherein a portion of the groove is located in the radially disposed surface and extends axially beyond the radially disposed surface.

3. The piston assembly of claim 1, wherein:
the indent includes a substantially circumferentially disposed surface; and,
a portion of the groove extends radially inward from the circumferentially disposed surface.

4. The piston assembly of claim 1, wherein:
a first portion of the groove is located in the radially disposed surface and extends axially beyond the radially disposed surface;
the indent includes a substantially circumferentially disposed surface;
a second portion of the groove extends radially inward from the circumferentially disposed surface; and,
the first and second portions are directly connected.

5. The piston assembly of claim 1, wherein:
a first portion of the groove is located in the radially disposed surface and extends axially beyond the radially disposed surface;
the indent includes a substantially circumferentially disposed surface;
a second portion of the groove extends radially inward from the circumferentially disposed surface; and,
when the sealing element is sealed against the radially disposed surfaces, the first and second portions of the groove form the flow path.

6. A piston assembly, comprising:
a back plate;
a piston fixed to the back plate and including:
an indent circumferentially disposed proximate an outer circumference for the piston plate and including a radially disposed surface; and,
a groove in the indent;
a sealing element at least partially disposed in the indent; and,
at least one resilient element in contact with the piston and applying a first force to urge the sealing element in a first axial direction to create a gap between the piston and the sealing element, wherein:
when the gap is present, the groove provides a flow path from the back plate to the gap; and,
when the sealing element is sealed against the radially disposed surface the flow path is blocked.

7. The piston assembly of claim 6, wherein the seal is displaceable to seal against the piston in response to a second force, greater than the first force, exerted on the sealing element in a second axial direction, opposite the first axial direction.

8. The piston assembly of claim 6, wherein:
the indent includes a substantially circumferentially disposed surface; and,
the groove extends radially inward beyond the circumferentially disposed surface.

9. The piston assembly of claim 6, wherein the at least one resilient element is separate from the sealing element and the piston.

10. The piston assembly of claim 6, wherein the at least one resilient element is formed of a same piece of material as the sealing element.

11. The piston assembly of claim 10, wherein:
the at least one resilient element includes at least one tab connected at one end to the sealing element; and,
the at least one tab is biased so that a distal end of the at least one tab extends axially away from the sealing element.

12. The piston assembly of claim 11, wherein:
the sealing element includes at least one indentation in a radially disposed surface facing the piston; and,
in response to a second force, greater than the first force, exerted on the sealing element in a second axial direction, opposite the first axial direction, the sealing element is displaceable such that the at least one tab is engaged with the piston and is displaced into the at least one indentation.

13. The piston assembly of claim 6, wherein:
the back plate is disposed in a chamber including hydraulic fluid; and,
when the gap is present, air in the hydraulic fluid can be bled through the groove to the gap.

14. A piston assembly, comprising:
a back plate;
a piston fixed to the back plate with a plurality of fasteners and including:
an indent circumferentially disposed proximate an outer circumference for the piston plate and including a radially disposed surface and a circumferentially disposed surface; and,
a groove in the indent extending radially inward from the circumferentially disposed surface;
a sealing element at least partially disposed in the indent; and,
at least one resilient element in contact with the piston and applying a force to urge the sealing element in an axial direction to create a gap between the piston and the sealing element, wherein:
when the gap is present, the groove provides a flow path from the back plate to an outer circumference of the piston; and,
when the sealing element is sealed against the radially disposed surface the flow path is blocked, wherein:
the at least one resilient element is separate from the sealing element and the piston; or,
the at least one resilient element is formed of a same piece of material as the sealing element.
